(19) United States
(12) Patent Application Publication
(10) Pub. No.: US 2004/0057877 A1
(43) Pub. Date: Mar. 25, 2004

(54) Solid phase substrates for structured reaction substrates

(76) Inventors: Markus Rarbach, Koln (DE); Andre Koltermann, Koln (DE); Ulrich Kettling, Koln (DE)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/451,306

(22) PCT Filed: Dec. 20, 2001
(86) PCT No.: PCT/EP01/15128

(30) Foreign Application Priority Data
Dec. 20, 2000 (EP) 00127996.7

(51) Int. Cl. B32B 5/02

(52) U.S. Cl. 422/101

(57) ABSTRACT

Described is a solid phase substrate (F, M) for adhesive coupling with at least one reaction substrate which includes at least one connecting layer (2) which is fixed to a solid phase layer (1), accounts for at least one functional area (3) of the solid phase layer (1) and consists of a material that forms an adhesive connection with surfaces of polymeric, plastic, glass or semi-conducting materials or metal. Also described is a functional reaction substrate with such a solid phase substrate and methods for sample processing.

The invention relates to a solid phase substrate, a composite of reaction and solid phase substrates and methods for the processing of fluid samples in at least one reaction substrate.

Structured reaction substrates (or: sample carriers) for the accommodation and parallel manipulation of a multitude of samples have great importance in biochemistry, medicine and gene technology. Apart from the increase in the number of samples per sample carrier and the reduction in the sample volume (miniaturization), an increase in the number of the manipulations that can be performed on the reaction substrates (functionality) is concomitantly aspired to. An important subgroup of functions of reaction substrates that are to be realized are characterized by interactions of the liquid sample with solid materials that are, for example, by means of a solid phase substrate brought in contact with the sample in a reservoir of the reaction substrate. Various functions of the solid phase substrate are to be assigned to this group, such as filtration of liquid samples for separation of particulate sample components, reactions at solid surfaces, with the surface carrying a substance that participates in the reaction or being made of such substances, as well as physical interactions of sample components with surfaces or substances bound to it.

Solid phase functionalized reaction substrates, especially for the filtration of samples, are known. A drawback of these known embodiments of reaction substrates in the sense of the aforementioned applications is the fact that the functional layer is linked tightly to the reaction substrate. Thus, membranes or filters are linked irreversibly with a reaction substrate, thereby defining the sample compartments. Respective reaction substrates are for example described in U.S. Pat. No. 4,797,259.

In U.S. Pat. No. 5,009,780 (and accordingly in EP 408 940), reaction substrates are described in which solid phases (filter membranes) are coupled with reaction substrates, which permit the separation of the filter membranes from the reaction substrate. Here, isolation of filtrate and retentate as well as determination of filtrate properties of a multitude of samples are possible. The filter medium, however, can only be isolated for each sample compartment separately, so that parallel processing is only possible when the filter medium is linked to the reaction substrate. Recombination of the functional layer with another reaction substrate or the direct determination of the physicochemical properties of the retentate bound to the functional layer are not possible. Recoupling of the functional layer with another reaction substrate is not possible. Furthermore, the assembly of the functionalized reaction substrate is complex, since each sample compartment is separately linked with the solid phase. A transfer of the principle of U.S. Pat. No. 5,009,780 to reaction substrates with a large number of sample compartments (>100 per reaction substrate) is technically unreasonable.

In U.S. Pat. No. 4,317,726, U.S. Pat. No. 5,047,215 and U.S. Pat. No. 4,493,815, solid phase elements are fixed mechanically reversible between reaction substrates. The functional layer can be separated from the reaction substrate. The seal of the filter against the reaction substrate as well as the mutual seal of the sample compartments are here achieved by mechanical pressure on the solid phase element by the reaction substrate or by sealing elements which are additionally inserted between reaction substrate and solid phase element (U.S. Pat. No. 4,493,815). The sealing pressure is achieved by bolting the assembly of reaction substrate and solid phase together (U.S. Pat. No. 4,317,726, U.S. Pat. No. 4,493,815). This assembly requires on the one hand an elaborate construction of the reaction substrates, since the required sealing forces have to be absorbed by the reaction substrate, and also hinders the automatic handling of a multitude of sample carriers since the separation of sample carrier and solid phase requires complex handling of the reaction substrate. Since the sealing forces have to be absorbed by the solid phase, potential damage to the solid phase is a problem, especially in mechanically unstable membrane materials. In U.S. Pat. No. 5,047,215, the splitting of the membrane by the sealing forces is utilized for separation of the membrane compartments of adjacent sample compartments. Separation of solid phase and reaction substrate and recombination with other reaction substrates is thus not possible. None of the mentioned solid phase-functionalized reaction substrates allows coupling with substrates with other functionality. Particularly the parallel transfer of liquid samples into reaction substrates for spectroscopic measurement of physicochemical properties is not possible.

Further disadvantages of the usual solid phase substrates are their limited utility. The solid functional elements should for example not hinder the measurement of physicochemical properties of the sample. Also, it may be necessary to conduct complex series of manipulations on the sample. These series have so far required serial transfers of the samples into other reaction substrates. Such serial steps are labor extensive, with respect to both time and equipment.

It is the object of the invention to provide improved solid phase substrates, with which the disadvantages of the conventional solid phase substrates can be overcome. In particular, it is the object of the invention to provide solid phase substrates for structured reaction substrates, the functional layers of which are freely combinable with any functions of the reaction substrates, without limiting the application options of the reaction substrates themselves or other possible manipulations of the reaction substrate or the functional layer. Particularly, the functional layer should be separable from the reaction substrate without loss of the retentate or filtrate, and should, if necessary, be combinable with another reaction substrate to yield a functionalized reaction substrate. It is also the object of the invention to provide methods for the manufacture and application of solid phase substrates.

These objects are solved by a solid phase substrate, a functionalized reaction substrate and a method having the characteristics of the patent claims 1, 9, 13 or 18. Advantageous embodiments and applications of the invention result from the dependent claims.

The basic idea of the invention is to provide a solid phase substrate that is formed of a solid phase layer with at least one functional area, with at least one connecting layer being provided on the solid phase layer, that consists of a material that forms an inherent, reversible adhesive linkage with solid body surfaces. Depending on the application, the material is selected for adhesion to solid body surfaces consisting of polymer, plastics, glass or semi-conducting materials or metals. The surface of the connecting layer is adapted to the respective solid body surface. According to a preferred embodiment of the invention, the connecting layer is a polymer layer that is formed by an elastomer with adhesive properties. It preferably consists of silicone, especially polydimethylsiloxane (PDMS) or also, e.g., of a natural or a synthetic rubber, polyurethane with adhesive properties, polyisoprene or acrylic elastomers. The connecting layer forms an adhesive bond with a smooth (e.g. molded, polished or calendered) solid body surface. The use of the polymer layer has the advantage that the solid phase substrate may be combined with any substrate, especially reaction substrates, providing the respective solid body surfaces.

Providing the solid phase layer with the adherent connecting layer has the advantage that through the connecting layer, the solid phase substrate may be fastened stably to a reaction substrate without an adhesive or a separate connection with a relatively simple, integrative assembly for the duration of sample treatment, and may subsequently be removed especially undamaged for further treatment steps and/or may be linked to another reaction substrate.

The connecting layer is provided to be one-sided or two-sided on the solid phase layer. Several connecting layers may be provided on the one or on both sides of the solid phase. A two-sided connecting layer has the advantage that an assembly of one reaction substrate and one solid phase substrate can be combined with at least one other reaction substrate and/or a covering layer made of at least partly impermeable material (e.g. glass).

Particular advantages result from the solid phase substrate having a connecting layer with a multitude of recesses, which correspondingly leave a multitude of functional layers of the solid phase layer uncovered. The functional areas are formed according to the arrangement and form of reservoirs of a reaction substrate. Usually, a substrate or carrier with at least one sample reservoir in which a fluid sample can be taken up is called reaction substrate. According to the invention, the form, size and arrangement of the functional areas can correspond to the geometry of the sample reservoirs of the reaction substrate. Alternatively it may be advantageous if several functional areas are assigned to one sample reservoir each, or, conversely, if several sample reservoirs are assigned to one functional area each.

The solid phase substrate is connected via the connecting layer with the reaction substrate. This embodiment of the inventions allows advantageously that in the connection with the reaction substrate parallel processing of a multitude of samples or also recombination of the solid phase substrate with another reaction substrate or direct measurement of physicochemical properties at the functional areas (or the thereon bound retentates) are possible.

A subject of the invention is also a functionalized reaction substrate representing a composite of at least one reaction substrate and at least one solid phase substrate, which are solely connected with each other by adhesion. The connection of solid phase and reaction substrates for manufacture of functionalized reaction substrates is advantageously simple and may be conducted in an automated process, if necessary. The manufacture of a functionalized reaction substrate is preferably conducted by fixing the solid phase substrate to the reaction substrate by pressing them together.

Particularly, the above object is solved by a solid phase substrate on which a solid, adhesive, liquophobic layer is applied as a connecting layer in certain areas, so that adhesive coupling between reaction and solid phase substrate is formed in a stack-like assembly of reaction substrates and solid phase substrates. The coating of the solid phase layer preferably excludes the areas of the solid phase corresponding to the sample compartments of the reaction substrates used. Subject of the invention is also a method for manufacturing the solid phase substrate. In an especially preferred embodiment, as coating materials, polymers (especially silicones) are used which are applied in the liquid state to the solid phase and polymerize to form a solid, flexible, adhesive coating. Alternatively, the connecting layer may also be glued to the solid phase layer. The manufacture of the solid phase substrates is technically relatively simple, so that they can advantageously form single-use products.

For the manufacture of the coated solid phase substrate, printing technology methods are used in a preferred embodiment. In an especially preferred embodiment, screen processes are used to selectively apply the coating material of the connecting layer to areas of the solid phase, which serve the coupling between solid phase substrate and reaction substrate in combined, functionalized reaction substrates. In the screen process, suitable structured coatings can be applied with resolutions up to several μm to solid surfaces. Screen printing templates can easily be produced with lithographic methods and adjusted by selection of the screen printing fabric and coatings used to the properties of the polymers to be processed and the materials to be printed.

The silicone materials that are preferably used for manufacture of the solid phase substrate and/or the reaction substrate are mostly inert to chemical and biochemical reaction conditions. A multitude of corresponding materials, especially for coating of surfaces, are known as such and available to the skilled person. Silicones, especially PDMS, form non-covalent, adhesive bound with solid body surfaces. The bonds between surface and silicone substrate are reversible. A multitude of bonding-separation cycles can be conducted without substantially decreasing the adhesion properties of the silicone substrate. This is described e.g. in the later published patent applications DE 199 48 087.7 and PCT/EP00/09808.

In the stack-like, solid phase functionalized reaction substrates made of coated solid phase and reaction substrates described here, the adhesive coupling maintains the integrity of solid phase and reaction substrate without the necessity of a form-fixing linkage of the components. The combined functionalized reaction substrates can be handled as a unit manually or, if necessary, automatically.

Simultaneously, the adhesive coupling between solid phase and reaction substrate results in sealing of the coupled areas, so that the leak of liquid sample components from the reaction substrate and the exchange of liquid components between reaction compartments is avoided. The solid phase substrate may be separated from the reaction substrate without damage of the solid phase substrate or the reaction substrate itself. Reaction substrate as well as solid phase can then be combined with other reaction substrates or components of reaction substrates, so that reaction substrates with other or equal function are generated by the recombination. This reversible and repeatable coupling of functional elements and reaction elements allows the parallel performance of complex manipulation series with a multitude of samples.

Advantageously, solid phase substrates according to the invention can alone, i.e. without the linkage to a reaction substrate, be subjected to a determination of physicochemical properties, i.e. the integrity of the sample layer remains intact even after the separation from the reaction substrate.

By selection of the material of the solid phase, various functions of a solid phase functionalized reaction substrate can be achieved.

A further advantage of the connecting layer is that the solid phase layer of a solid phase substrate is mechanically stabilized and protected against destruction. Thus, new and especially thinner or more brittle solid phase materials, with which solid phase reactions have so far been feasible only in restricted manner, become accessible for the use for the processing of fluid samples.

Further advantages and details of the invention are described in the following, referring to the attached drawings. They show:

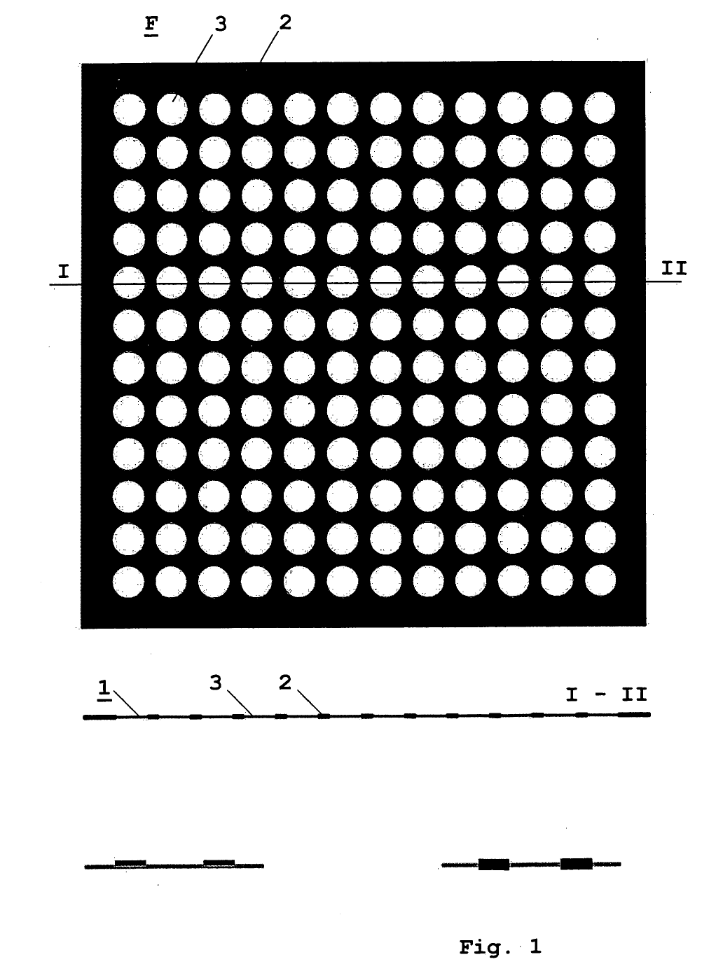

FIG. 1 schematic representations of an embodiment of a solid phase substrate according to the invention;

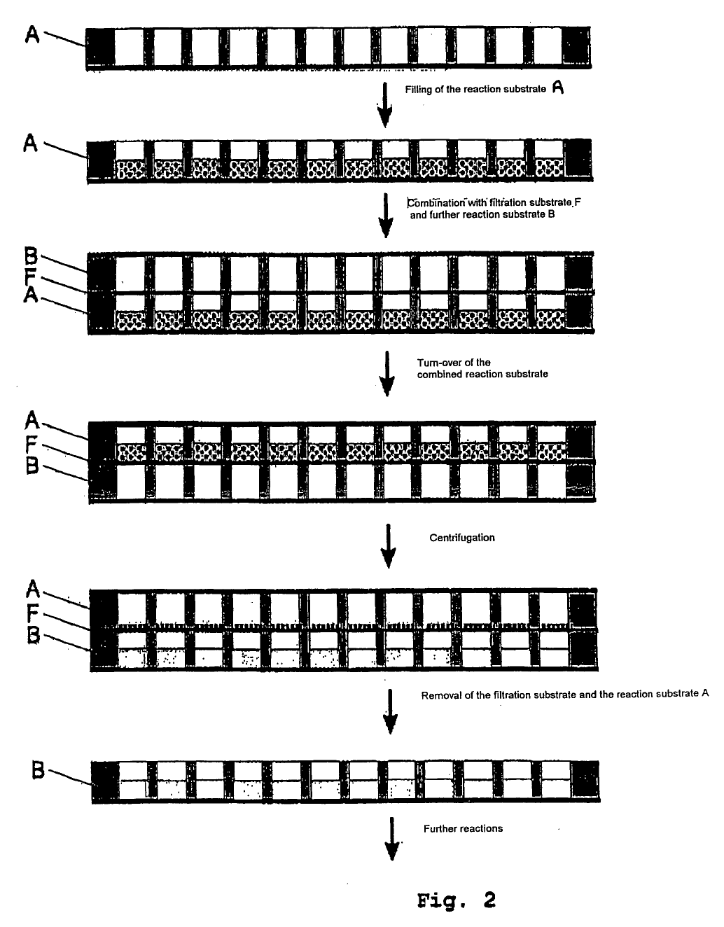

FIG. 2 a procedure for the use of a reaction substrate according to the invention for filtration;

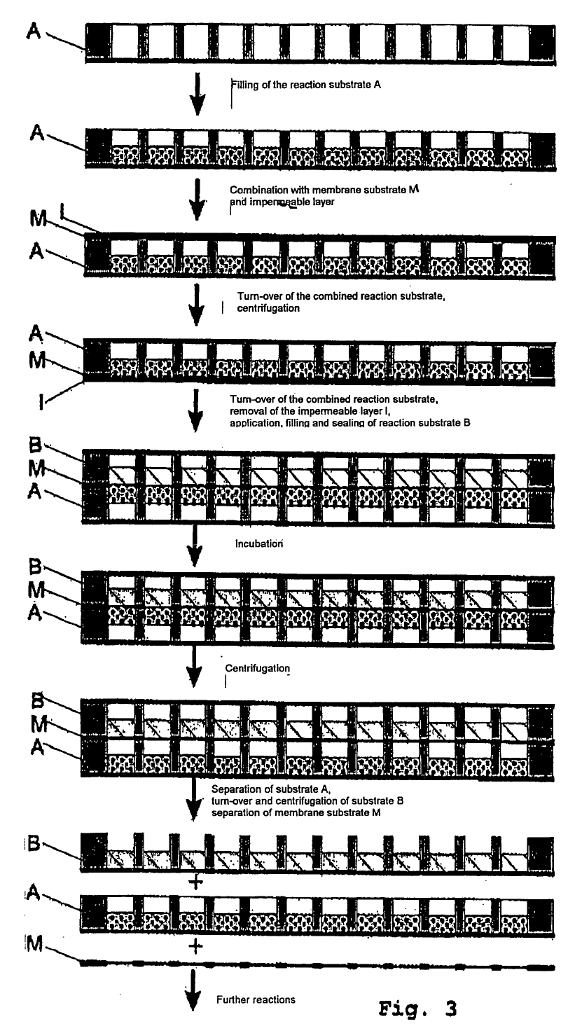

FIG. 3 a procedure for use of a reaction substrate according to the invention for sample treatment;

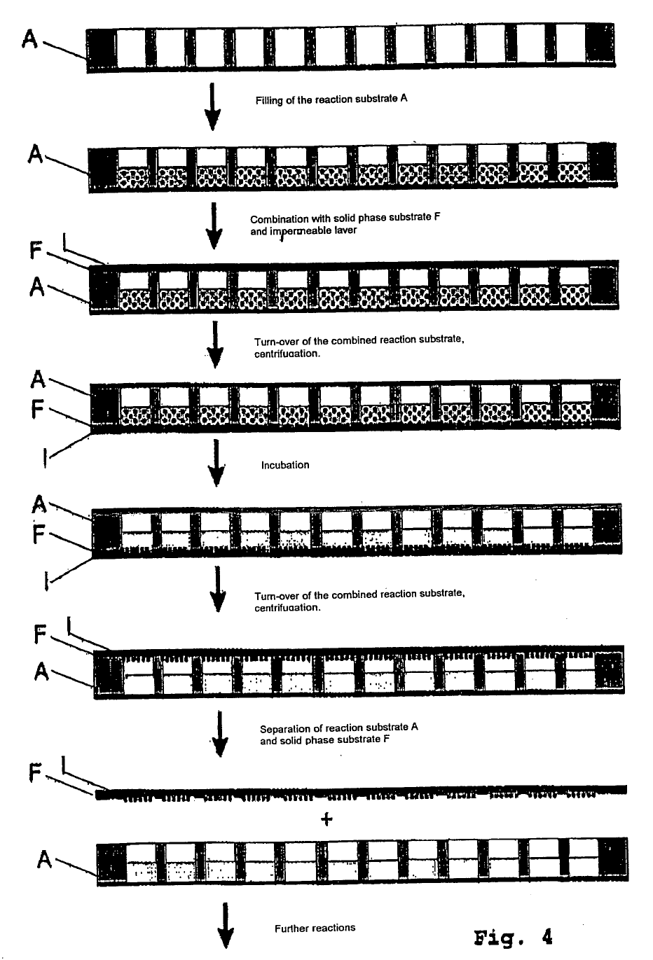

FIG. 4 a procedure for use of a reaction substrate according to the invention for conducting solid phase reactions;

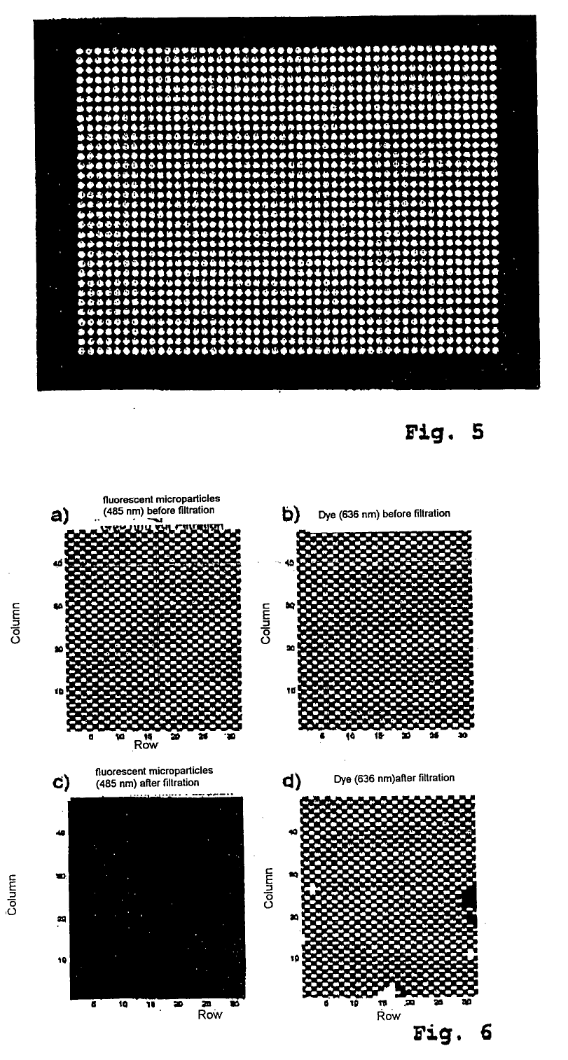

FIG. 5 a lithographic template for generating of the screen print template for a solid phase substrate according to the invention;

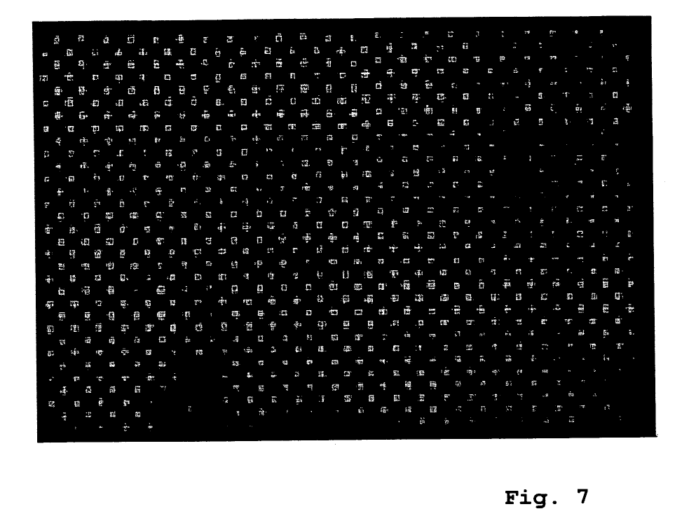

FIG. 6 an illustration of the spectrometric examination of samples that are treated according to the invention; and

FIG. 7 an illustration of the spectrometric measurement of a retentate analyzed according to the invention.

In the following, the invention is described with reference to a solid phase substrate which is provided for combination with a reaction substrate with a multitude of sample reservoirs. The invention, however, is not limited to solid phase substrates with a multitude of functional areas, but can also be correspondingly implemented as a solid phase substrate with a single functional area. Furthermore, the following description refers to a preferred embodiment of the invention in which the connecting layer formed on the solid phase layer of a solid phase substrate is made of silicone or other plastics. The silicone forms a connection with a reaction substrate and/or a covering layer, which also consist of silicone or plastic, glass or semi-conducting materials. The invention can be implemented analogously with solid phase substrates in which the connecting layer consists of polymer, chemically organic plastic, glass or semi-conducting material or metal, and forms an adhesive connection with the reaction substrate and/or the covering layer made of silicone or another adhesive material.

In the embodiment of a solid phase substrate F according to the invention which is illustrated in FIG. 1 in schematically enlarged planar and side views, a connecting layer 2 is formed on a solid phase layer 1 (see sectional view I-II). The connecting layer 2 is structured with recesses so that the solid phase layer 1 is uncovered at the functional areas 3. The functional areas 3 form the desired solid phases with which fluid samples are intended to be brought in contact. The connecting layer 2 can be applied one-sided (FIG. 1, insertion lower left) or two-sided and/or permeating (FIG. 1, insertion lower right) on the solid phase layer 1.

The solid phase substrate F preferably forms a planar, flexible layer but can also be curved according to the form of a predetermined reference surface depending on the application. Depending on the application, the solid phase layer 1 consists of a solid phase material, as it is known as such from usual solid phase substrates. The thickness of the solid phase layer is e.g. in the range of approx. 1 μm to 10 mm, preferably in the range of 100 μm to 1 mm. The surface dimensions and forms of the solid phase substrate F and the functional areas 3 are selected depending on the application according to the dimensions of a reaction substrate and the reservoirs for fluid samples formed in it. The solid phase substrate F shown in FIG. 1 has for example 144 functional areas 3 arranged in straight lines and columns. Solid phase substrates according to the invention advantageously do not represent a limitation with respect to the surface dimensions of the functional areas.

Manufacture Of The Solid Phase Substrate

If a porous solid phase material is used, the liquophobic coating material and the coating method are selected in a preferred embodiment of the invention in such way that in the process of the coating, the coating material permeates the porous solid phase (FIG. 1: sectional view I-II).

The coating process of the solid phase material with the adhesive liquophobic coating materials can only be performed from one side of the material (FIG. 1: lower left) or in equal selection of the coated areas from both sides of the solid phase material (FIG. 1: lower right). The solid phase substrate can thus be coupled at the same time with two reaction substrates or components of reaction substrates.

The two-sided coupling of a solid phase substrate with two reaction substrates permits the parallel processing and transfer of liquid sample components from one reaction substrate into another. The two substrates may show equal or different functionalities.

Printing technology procedures are preferably used as coating procedures for generating the connecting layer 2 on the solid phase layer 1. Printing templates for various reaction substrates may be generated and transferred lithographically to screen printing fabrics. The screen printing fabrics used may be adjusted to the chemical and rheological properties of the polymer to be processed according to procedures known to the skilled person. For generation of a solid phase substrate for a reaction substrate with 1536 sample reservoirs (sample compartments, see FIG. 5), for example a screen printing fabric (27 threads/cm) with solvent-resistant photo lacquer coating (50 μm layer thickness) is used. The screen printing template is exposed to the lithography mask represented in FIG. 5 (manufacture of the screen printing template by the company “Werbung & Druck”, Gottingen).

As coating polymer, a commercially available product is used (Wacker Finish CT 51 L, Wacker Chemie GmbH, Munich). The selected polymer is prepared according to the manufacturer's specification and has a wet life of several hours (manufacturer's specification). The polymerization of the material takes place after each coating step by incubation of the coated solid phase element at a temperature of 100° C. for 2 minutes.

The solid phase layer consists e.g. of a filtration material which is formed by cellulose acetate membrane with a pore size of 1.2 μm (Schleicher & Schull, product No. ST 69). The filtration material is fixed by adhesion within the boundary areas of the filtration membrane that do not have to be printed on a smooth, solid support. The fluid polymer is applied to the solid phase material using the screen printing template. Each coating step is followed by a polymerization step. Two-sided coating of the solid phase substrate requires congruent application of the polymer layers in both coating procedures. The positioning of screen printing templates and solid phase substrate may be controlled visually after application of control marks after the first coating procedure.

The solid phase substrate produced in this way is combined with silicone reaction substrates, with the distribution of the reaction compartments corresponds to the screen printing template of the solid phase element illustrated in FIG. 5. Corresponding reaction substrates are for example described in the application PCT/EP00/09808 (DE 199 48 087.7). The silicone reaction substrate with a thickness of 4 mm can hold 1536 sample compartments and can be sealed at the bottom and/or top periphery by a planar glass plate, which is adhesively bound to the reaction substrate.

FIG. 1 shows as an important characteristic of the invention that each functional area in the substrate plane is surrounded completely by the connecting layer and/or a part of the connecting layer penetrating into the solid phase layer. Adjacent functional areas are isolated in relation to each other. Fluid contact (contamination) between adjacent solid phases is excluded. However, the lateral, fluid-sealed inclusion of the functional areas does not necessarily require the formation of a continuous connecting layer.

In the following, various procedures in the use of solid phase and reaction substrates according to the invention are described.

Filtration

FIG. 2 shows a procedure to illustrate the use of an assembly according to the invention of a first reaction substrate A and a solid phase substrate F in combination with another reaction substrate B.

For filtration of samples, filtration media may be provided with the mentioned adhesive connecting layer as the solid phase layer. Filtration fabrics or papers with nominal pore sizes between 10 μm and 500 μm, or fiber glas filters with nominal pore sizes between 1 μm and 100 μm are used as filtration media in a preferred embodiment; in a further especially preferred embodiment, porous filtration membranes are used with nominal pore sizes between 0.1 μm and 10 μm, especially with pore sizes between 0.1 μm and 2 μm. According to an alternative, preferred embodiment, ultrafiltration membranes with a nominal cut-off size between 1 nm and 100 nm can be used. All mentioned materials are as such known and available to the skilled person.

The solid phase substrate F, which is provided two-sided with the liquophobic coating, is coupled adhesively with the first structured reaction substrate A, the sample compartments of which carry the fluid samples. The coupling is carried out for example by application of the solid phase substrate F on the reaction substrate A, so that the reaction surfaces and the sample reservoir are aligned. Then, the solid phase substrate F is pressed on manually or using an adjustment device (e.g. using a stamp corresponding to the surface of the reaction substrate), so that the adhesive connection between both parts is formed. On the solid phase substrate F which is bound to the first reaction substrate A, a second reaction substrate B is applied, so that the solid phase substrate F is present in a stack-like assembly between the first reaction substrate A and the second reaction substrate B. After turning over the combined reaction substrate A-F-B, the fluid samples can be transferred from the first into the second reaction substrate by centrifugation. In this step, filtrate and retentate are separated. The filtrate can be isolated in the reaction substrate B, whereas the retentate remains at the solid phase substrate F or in the combined reaction substrate consisting of reaction substrate A and solid phase substrate F. As far as the reaction substrate (sample carrier) B has corresponding functionality, the filtrate can be used for determination of physicochemical properties, either immediately or after removal of reaction substrate A and solid phase element F, or fluid samples or the solid phase substrate F loaded with the retentate can, if necessary, be subjected to further reactions/procedures after combination with other reaction substrates or parts of reaction substrates.

Diffusion Processes

According to a further embodiment of the invention, functionalized reaction substrates are provided, which permit diffusive transport processes through solid reaction elements. Such reaction elements provided as solid phases may for example be made of materials which selectively permit or prevent the selective exchange of substances due to specific physicochemical properties such as molecular size, charge or hydrophobic/hydrophilic properties, or combinations of these properties.

A procedure using a solid phase substrate, in which the functional areas form the mentioned reaction elements, is illustrated in FIG. 3. FIG. 3 shows the use of an assembly including a first reaction substrate A with a solid phase substrate which is formed by a membrane substrate M, in combination with a second reaction substrate B or a covering layer I. The functional areas of the membrane substrate (reaction elements) are for example semi-permeable membranes with cut-off limits between 1 nm and 100 nm. These membranes permit the selective exchange of low molecular substances between fluid samples.

Especially in small sample compartments, fluid samples adhere to the upper solid boundary of a sample compartment due to the surface tension of the sample fluid, even after turning over of the reaction substrate, so that in the embodiment shown in FIG. 3, fluid samples in the two reaction substrates A and B can be brought in contact through the membrane substrate M. The selective substance transport between the fluid samples can be due to concentration gradients between the samples as well as to external forces such as for example gradients of an external electric field. To make a correspondingly functionalized reaction substrate according to FIG. 3, a reaction substrate A is filled with fluid samples, combined with the membrane substrate M and sealed with the impermeable covering layer I. By turning over the substrate and combination with a second reaction substrate B, a combined reaction substrate is formed, in which a multitude of fluid samples in the reaction substrates A and B can be brought in contact through the membrane substrate M. After the substance exchange is finished, the fluid samples in the mentioned reaction substrates A and B can be separated from each other by centrifugation and separation of the combined reaction substrate.

Reaction

FIG. 4 shows a procedural outline for use of solid phase substrates and functionalized, combined reaction substrates realized in embodiments permitting adsorption, desorption or reaction of substances with solid surfaces. Again, a reaction substrate A is provided with a solid phase substrate F, being covered with the impermeable layer I.

For reaction of a fluid sample or particles which are suspended in a fluid sample, on a solid surface or on a substance bound to a surface, a reactive solid phase that is formed like a layer or membrane can be provided one-sided or two-sided with the mentioned adhesive connecting layer. An one-sided layer is generally sufficient when the reactive solid phase itself is non-permeable for the fluid reaction partner or for components of the fluid samples. If the reactive solid phase itself is permeable for the fluid reaction partner or for components of the fluid samples, the solid phase can be provided two-sided with the mentioned adhesive coatings. As shown in FIG. 4, in this embodiment, the reaction compartments of the reaction substrate A, that are filled with the fluid samples, can be sealed after application of the coated reactive solid phase F and, if necessary, of a layer of an impermeable material I that does not participate in the reaction.

By turning over (if necessary additionally by centrifugation) of the combined reaction substrates, the fluid sample can be brought in contact with the solid phase or be separated from it after the reaction. After the reaction is finished, the fluid samples in the reaction substrate A and the solid phase substrate F can be separated and both can be used for determination of physicochemical properties, or samples or solid phase substrate can be used for further reactions/process steps.

Bonding

Analogously, bonding of components of a fluid samples on a solid surface or with a substance bound to a surface may take place, for which purpose an adsorptive solid phase, formed like a layer or membrane, can be provided one-sided or two-sided with the adhesive connecting layer. An one-sided coating is then sufficient, when the adsorptive solid phase itself is non-permeable for the fluid reaction partner or components of the fluid samples. If the adsorptive solid phase itself is permeable for the fluid reaction partner or components of the fluid samples, the solid phase can be provided two-sided with the mentioned adhesive coatings. The reaction compartments can then be sealed after application of the coated, reactive solid phase with an impermeable material that does not participate in the reaction. As shown in FIG. 4, the adsorptive solid phase F can be combined with a reaction substrate A filled with fluid samples.

By turning over (if necessary additionally by centrifugation) of the functionalized reaction substrates, the fluid sample can be brought into contact with the solid phase or be separated from it after the reaction. After the reaction is finished, the reaction substrate A and the solid phase substrate F can be separated from each other, and both can be used for determination of physicochemical properties, or samples or solid phase substrate can be used for further reactions/process steps. In the same way, functionalized reaction substrates can be made, the solid phase function of which is based on desorption of a solid phase bound substance by action of a fluid sample or components of the fluid samples. The adsorption/desorption of substances themselves can be observed herein by determination of the physicochemical properties of the fluid sample and of the solid phase-bound sample components.

Since the solid phase substrates permit repeated coupling to reaction substrates, the embodiments described here can be implemented consecutively in a fixed series of manipulations or be realized by coupled manipulation of the fluid samples in a procedural step. In an especially preferred embodiment, a functionalized reaction substrate can be made for reactive reaction of a solid phase-bound reactant with subsequent desorption of reaction products in the fluid sample. If a reaction substrate with suitable functionality is used, the subsequent determination of physicochemical properties of the sample is possible. In a further preferred embodiment, reaction and filtration functionalities of the solid phase substrate can also be coupled by binding reactive components to a suitable porous filtration material. In this way, particulate sample components participating in the reaction can be separated, if necessary, after finishing the reaction. This functional combination can be desirable since particulate components can hamper the determination of physicochemical properties of the sample, or since the reaction must be stopped by separation of the particulate solid substances.

Measurement Of Results

The excellent filtration properties of the solid phase substrate according to the invention are confirmed by the fluorescence measurements that are described in the following. The measurements were carried out with a suspension of fluorescent microparticles (fluospheres 505/515, diameter 2 μm, Molecular Probes, Eugene, Oreg., USA) in a fluorescent dye solution (Cy5-succinimidyl ester, Molecular Probes, Eugene, Oreg., USA). Dye and particles can be distinguished by fluorescence spectrometry due to different absorption and emission properties. Whereas the quantity of the used particles can be quantified by the fluorescence emission in the wavelength region between 530 and 560 nm at an excitation wavelength of 485 nm, the quantity of the used dye is determined by fluorescence emission in the wavelength region between 665 and 735 nm at an excitation wavelength of 635 nm. For determination of the fluorescence properties of the samples, a microplate reader is used (SpectraFluor, TECAN, AT).

The reaction compartments of a reaction substrate one-sided sealed with a glass plate (compare FIG. 6) are filled alternately (“checker-board pattern”), with 1.3 μl water (ultrapure water, HPLC grade) or with the above mentioned suspension of fluorescent microparticles. The composition of the fluid samples is determined as described before and after the filtration by fluorescence spectrometry.

The functionalized reaction substrate is made as described and shown in FIG. 2, with the first reaction substrate A which is filled with the fluid samples, the generated filtration substrate F and a further reaction substrate B which is identical to the first reaction substrate.

Filtrate and retentate are separated by centrifugation (Heraeus Megafuge 1.0, swing-out rotor for microplates Nos. 7586, 2800 rpm, 30 min). After finishing the centrifugation, the reaction substrates A and B are separated from the filtration substrate F. The sample filtrates in reaction substrate B and the sample retentates adhering to the filtration substrate F are used for the determination by fluorescence spectrometry.

The results of the fluorescence-spectrometric measurements of the particle suspension before the centrifugation and the measurements of the filtrate after the centrifugation are represented in FIG. 6, in which chart a shows the fluorescence emission of the suspended particles before centrifugation, b shows the fluorescence emission of the dissolved dye before centrifugation, c the fluorescence emission of the suspended particles after centrifugation and d the fluorescence emission of the dissolved dye after centrifugation.

The measurements of the fluid samples before and after the centrifugation were carried out under identical measurement conditions. To distinguish the fluorescence signal from particle suspension and control samples (water), a threshold of 5000 (count values) counts is determined for all measurements. Sample compartments with a fluorescence emission above the threshold are shown in white, sample compartments with a fluorescence emission under the threshold are shown in black. The measurement of the used samples in FIGS. 6a and b shows alternating fluorescence signals corresponding to the selected dispensing scheme (“checker board pattern”). The fluorescence measurements of the samples after filtration in FIGS. 6c and d show the reduction in the fluorescence signal originating from the used fluorescent microparticles (FIG. 6c) below the threshold and therefore the removal of the used particles from the sample suspension by the filtration substrate, as well as the essentially unchanged fluorescence signals of the fluorescent dye in the filtrate that had not been retained by the used filtration medium.

Fluorescence spectrometric analysis (excitation wavelength 485 nm, fluorescence emission in the wavelength range of 530-560 nm) of the filtration substrate F isolated from the functionalized reaction substrate shows the emission signals of the retentate adhering to the filtration element (see FIG. 7). The determined distribution of the fluorescence corresponds to the dispensing scheme of the sample suspension.

The characteristics of the invention disclosed in the above description, the drawings and the claims can be important individually as well as also in any combination for the realization of the invention in its various embodiments.

1. A solid phase substrate (F, M) for adhesive coupling with at least one reaction substrate, the solid phase substrate (F, M) comprising a solid phase layer (1), characterized by
at least one connecting layer (3) which is tightly bound to the solid phase layer (1), excludes for at least one functional area (2) of the solid phase layer (1), and consists of a material which forms an adhesive bonding with surfaces of polymeric, plastic, glass or semi-conducting materials or metals.

2. The solid phase substrate according to claim 1, extending in correspondence to a predetermined, especially planar, reference surface, the at least one functional area (2) being limited on all sides by the connecting layer (3) towards the extension of the reference layer.

3. The solid phase substrate according to any of the previous claims, in which the solid phase layer (1) is a filter layer, a reactive layer, a semipermeable layer or an adsorptive layer.

4. The solid phase substrate according to any of the previous claims, in which the connecting layer (3) covers the solid phase layer (1) at least in part one-sided or two-sided.

5. The solid phase substrate according to any of the previous claims, in which the connecting layer (3) consists of silicone, especially PDMS.

6. The solid phase substrate according to any of the previous claims, in which the connecting layer (3) consists of a polymeric material which is arranged on the solid phase layer (1) permeating it at least partly.

7. The solid phase substrate according to any of the previous claims, in which the connecting layer (3) is arranged on the solid phase layer (1) according to a predefined geometric pattern.

8. The solid phase substrate according to any of the previous claims, in which a multitude of functional areas (2) is provided forming a matrix arrangement with straight rows and columns.

9. A functional reaction substrate, consisting of at least one reaction substrate with at least one sample reservoir and a solid phase substrate (F, M) according to one the previous claims.

10. The functional reaction substrate according to claim 9, in which each functional area (2) covers one sample reservoir.

11. The functional reaction substrate according to claim 9 or 10, forming a composite of a first reaction substrate (A) with the solid phase substrate (F, M) and a second reaction substrate (B) or a covering layer (I).

12. The functional reaction substrate according to claim 12, in which the solid phase substrate (F, M) is arranged on the first reaction substrate (A) and the second reaction substrate (B) is arranged on the solid phase substrate (F, M), so that the at least one sample reservoir of the second reaction substrate (B) is open towards the functional area (2) of the solid phase substrate (F, M).

13. A method for processing of fluid samples by interaction of the samples with a solid phase substrate (F, M) in a functional reaction substrate according to one of the claims 9 to 12.

14. The method according to claim 13, in which at the solid phase substrate (F, M) a filtration, a chemical reaction, especially a bonding reaction, a physical adsorption or desorption, and/or a substance-selective diffusion take place.

15. The method according to claim 13 or 14, in which the assembly of two reaction substrates (A, B) and a solid phase substrate (F, M) arranged between them is centrifuged.

16. The method according to one of the claims 13 to 15, in which, after processing of the samples, the solid phase substrate (F, M) or one or both of the reaction substrates (A, B) are separated from each other, and are separately subjected to further treatment or measurement steps.

17. The method according to claim 16, in which the solid phase substrate (F, M) or one or both of the reaction substrates (A, B), that are separated from each other, are combined according to one of the claims 9 to 12 with further reaction substrates (A, B) after the further treatment or measurement steps.

18. The method for making a solid phase substrate according to one of the claims 1 to 8, in which the material of the connecting layer (3) is applied on the solid phase layer (1) in fluid state according to the desired form and arrangement of the at least one functional area (2), and is linked with the solid phase layer (1) by polymerization, drying and/or curing, if necessary, with subsequent sintering and/or melting.

19. The method according to claim 18, in which the connecting layer (3) is applied with a screen process.
